(19) United States
(12) Patent Application Publication
(10) Pub. No.: US 2025/0379956 A1
(43) Pub. Date: Dec. 11, 2025

(54) METHODS AND SYSTEM OF INCIDENT BASED CAMERA DEVICE ACTIVATION IN A FIREFIGHTER AIR REPLENISHMENT SYSTEM HAVING BREATHABLE AIR SUPPLIED THEREIN

(71) Applicant: Rescue Air Systems, Inc., San Carlos, CA (US)

(72) Inventors: Nikolas Turiello, San Carlos, CA (US); Anthony J. Turiello, Westlake, TX (US)

(73) Assignee: Rescue Air Systems, Inc., San Carlos, CA (US)

(21) Appl. No.: 19/311,751

(22) Filed: Aug. 27, 2025

Related U.S. Application Data
(63) Continuation of application No. 18/207,144, filed on Jun. 8, 2023, now Pat. No. 12,418,633.
(60) Provisional application No. 63/356,996, filed on Jun. 29, 2022.
(60) Provisional application No. 63/357,754, filed on Jul. 1, 2022.
(60) Provisional application No. 63/357,743, filed on Jul. 1, 2022.
(60) Provisional application No. 63/359,882, filed on Jul. 11, 2022.
(60) Provisional application No. 63/413,616, filed on Oct. 6, 2022.

(51) Int. Cl. H04N 7/18; A62B 27/00; G16Y 40/50

(52) U.S. Cl. CPC H04N 7/188; A62B 27/00; G16Y 40/50

(57) ABSTRACT

Disclosed are methods and/or a system of incident based camera device activation in a safety system of a structure having a fixed piping system implemented therein to supply breathable air thereacross. In accordance therewith, one or more sensor(s) associated with one or more component(s) of the safety system is integrated with a computing platform executing on a data processing device. Based on the integration of the one or more sensor(s) with the computing platform, one or more environmental parameter(s) of the one or more component(s) of the safety system is sensed. One or more camera device(s) in a vicinity of and/or on the one or more component(s) of the safety system is automatically activated based on determining, from the sensing, occurrence of an incident.

### CROSS-REFERENCE TO RELATED PATENT APPLICATIONS

This application is a Continuation of U.S. application Ser. No. 18/207,144, filed Jun. 8, 2023, incorporated herein by reference in its entirety, which claims priority to, U.S. Provisional Patent Application No. 63/356,996 titled CLOUD-BASED FIREFIGHTING AIR REPLENISHMENT MONITORING SYSTEM, SENSORS AND METHODS filed on Jun. 29, 2022, U.S. Provisional Patent Application No. 63/413,616 titled VIDEO CAMERA AT EMERGENCY AIR FILL PANEL FOR INCIDENT COMMAND VISUAL AND TRANSCRIPTION OF AUDIO VIA MOBILE DEVICE filed on Oct. 6, 2022, U.S. Provisional Patent Application No. 63/357,743 titled CONTINUAL AIR QUALITY MONITORING THROUGH LOCALIZED ANALYSIS OF BREATHABLE AIR THROUGH A SENSOR ARRAY filed on Jul. 1, 2022, U.S. Provisional Patent Application No. 63/357,754 titled ON-DEMAND CERTIFICATION THROUGH COMMUNICATION OF ASSOCIATED AIR- QUALITY MARKER DATA TO A REMOTE CERTIFICATION LABORATORY filed on Jul. 1, 2022, and U.S. Provisional Patent Application No. 63/359,882 titled REMOTE MONITORING AND CONTROL OF A FIREFIGHTER AIR REPLENISHMENT SYSTEM THROUGH SENSORS DISTRIBUTED WITHIN COMPONENTS OF THE FIREFIGHTER AIR REPLENISHMENT SYSTEM filed on Jul. 11, 2022. The contents of each of the aforementioned applications are incorporated herein by reference in entirety thereof.

### FIELD OF TECHNOLOGY

This disclosure relates generally to emergency systems and, more particularly, to methods and/or a system of incident based camera device activation in a safety system of a structure having breathable air supplied therein.

### BACKGROUND

A structure (e.g., a vertical building, a horizontal building, a tunnel, marine craft) may have a Firefighter Air Replenishment System (FARS) implemented therein. The FARS may have an emergency air fill station therein to enable firefighters and/or emergency personnel access breathable air therethrough. The FARS may have other components relevant to critical functioning thereof. An incident (e.g., a fire, smoke/air pollution) occurring in the structure in a vicinity of one or more components of the FARS may endanger lives of the emergency personnel and/or people within the structure. Reducing chances of occurrence of the incident may warrant repeated monitoring of the FARS. Despite the careful monitoring, the incident may recur. Even if occurrence of the incident is controlled through painstaking design of the FARS based on the careful monitoring, another emergency situation resulting in casualties and/or damage to the structure may occur.

### SUMMARY OF THE INVENTION

Disclosed are methods and/or a system of incident based camera device activation in a safety system of a structure having breathable air supplied therein.

In one aspect, a method of a safety system of a structure having a fixed piping system implemented therein to supply breathable air thereacross is disclosed. The method includes integrating one or more sensor(s) associated with one or more component(s) of the safety system with a computing platform executing on a data processing device. The one or more component(s) relates to access of the breathable air within the safety system. The method also includes, in accordance with the integration of the one or more sensor(s) with the computing platform, sensing one or more environmental parameter(s) of the one or more component(s) of the safety system, and automatically activating one or more camera device(s) in a vicinity of and/or on the one or more component(s) of the safety system based on determining, from the sensing of the one or more environmental parameter(s), occurrence of an incident.

In another aspect, a safety system of a structure having a fixed piping system implemented therein to supply breathable air thereacross is disclosed. The safety system includes one or more component(s) related to access of the breathable air within the safety system. one or more sensor(s) associated with the one or more component(s), and a data processing device executing a computing platform thereon to integrate the one or more sensor(s) with the computing platform. In accordance with the integration of the one or more sensor(s) with the computing platform, the one or more sensor(s) senses one or more environmental parameter(s) of the one or more component(s), and a processor associated with the one or more sensor(s) automatically activates one or more camera device(s) in a vicinity of and/or on the one or more component(s) based on determining, from the sensing of the one or more environmental parameter(s), occurrence of an incident.

In yet another aspect, a method of a safety system of a structure having a fixed piping system implemented therein to supply breathable air thereacross is disclosed. The method includes integrating one or more sensor(s) associated with one or more component(s) of the safety system with a computing platform executing on a data processing device. The one or more component(s) relates to access of the breathable air within the safety system. The method also includes, in accordance with the integration of the one or more sensor(s) with the computing platform, sensing one or more environmental parameter(s) of the one or more component(s) of the safety system, and automatically activating one or more camera device(s) in a vicinity of and/or on the one or more component(s) of the safety system based on determining, from the sensing of the one or more environmental parameter(s), occurrence of an incident. Further, the method includes, in accordance with the automatic activation of the one or more camera device(s), capturing visual data and/or audio data of the incident.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic and an illustrative view of a safety system associated with a structure, according to one or more embodiments.

FIG. 2 is a schematic view of the safety system of FIG. 1 with elements thereof integrated therewithin in detail, according to one or more embodiments.

FIG. 3 is a schematic view of an emergency air fill station of the safety system of FIGS. 1-2 and an illustrative view of a context of an emergency event in an external environment thereof, according to one or more embodiments.

FIG. 4 is a schematic view of a computing platform relevant to the safety system of FIGS. 1-2 implemented through a server, according to one or more embodiments.

FIG. 5 is a schematic view of a data processing device of FIGS. 2-4, according to one or more embodiments.

FIG. 6 is an illustrative view of a command room of the safety system of FIGS. 1-2.

FIG. 7 is a schematic view of example environment sensors of the emergency air fill station of FIG. 3.

FIG. 8 is an example user interface view of a component of the data processing device of FIGS. 2-5.

FIG. 9 is a process flow diagram detailing the operations involved in incident based camera device activation in a safety system of a structure having breathable air supplied therein, according to one or more embodiments.

### Other features of the present embodiments will be apparent from the accompanying drawings and from the detailed description that follows.

### DETAILED DESCRIPTION

Example embodiments, as described below, may be used to provide methods and/or a system of incident based camera device activation in a safety system of a structure having breathable air supplied therein. Although the present embodiments have been described with reference to specific example embodiments, it will be evident that various modifications and changes may be made to these embodiments without departing from the broader spirit and scope of the various embodiments.

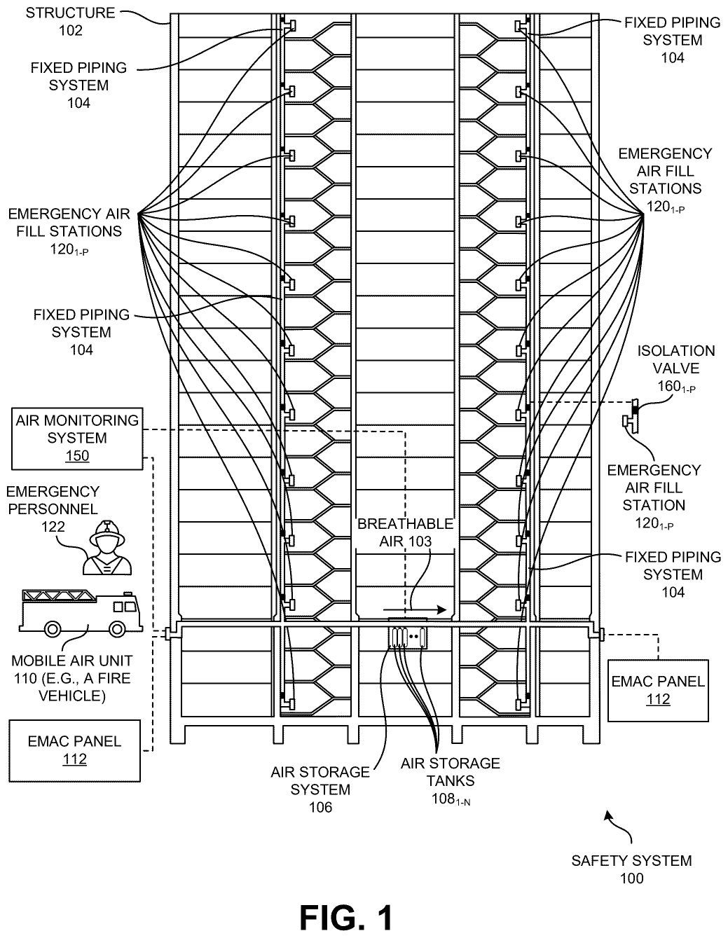

FIG. 1 shows a safety system 100 associated with a structure 102, according to one or more embodiments. In one or more embodiments, safety system 100 may be a Firefighter Air Replenishment System (FARS) to enable firefighters entering structure 102 in times of fire-related emergencies to gain access to breathable (e.g., human breathable) air (e.g., breathable air 103) in-house without the need of bringing in air bottles/cylinders to be transported up several flights of stairs of structure 102 or deep thereinto, or to refill depleted air bottles/cylinders that are brought into structure 102. In one or more embodiments, safety system 100 may supply breathable air provided from a supply of air tanks (to be discussed) stored in structure 102. When a fire department vehicle arrives at structure 102 during an emergency, breathable air supply typically may be provided through a source of air connected to said vehicle. In one or more embodiments, safety system 100 may enable firefighters to refill air bottles/cylinders thereof at emergency air fill stations (to be discussed) located throughout structure 102. Specifically, in some embodiments, firefighters may be able to fill air bottles/cylinders thereof at emergency air fill stations within structure 102 under full respiration in less than one to two minutes.

In one or more embodiments, structure 102 may encompass vertical building structures, horizontal building structures (e.g., shopping malls, hypermarts, extended shopping, storage and/or warehousing related structures), tunnels, marine craft (e.g., large marine vessels such as cruise ships, cargo ships, submarines and large naval craft, which may be “floating” versions of buildings and horizontal structures) and mines. Other structures are within the scope of the exemplary embodiments discussed herein. In one or more embodiments, safety system 100 may include a fixed piping system 104 permanently installed within structure 102 serving as a constant source of replenishment of breathable air 103. Fixed piping system 104 may be regarded as being analogous to a water piping system within structure 102 or another structure analogous thereto for the sake of imaginative convenience.

As shown in FIG. 1, fixed piping system 104 may distribute breathable air 103 across floors/levels of structure 102. For the aforementioned purpose, fixed piping system 104 may distribute breathable air 103 from an air storage system 106 (e.g., within structure 102) including a number of air storage tanks 108_{1-N} that serve as sources of pressurized/compressed air (e.g., breathable air 103). Additionally, in one or more embodiments, fixed piping system 104 may interconnect with a mobile air unit 110 (e.g., a fire vehicle) through an External Mobile Air Connection (EMAC) panel 112.

In one or more embodiments, EMAC panel 112 may be a boxed structure (e.g., exterior to structure 102) to enable the interconnection between mobile air unit 110 and safety system 100. For example, mobile air unit 110 may include an on-board air compressor to store and replenish pressurized/compressed air (e.g., breathable air analogous to breathable air 103) in air bottles/cylinders (e.g., utilizable with Self-Contained Breathing Apparatuses (SCBAs) carried by firefighters). Mobile air unit 110 may also include other pieces of air supply/distribution equipment (e.g., piping and/or air cylinders/bottles) that may be able to leverage the sources of breathable air 103 within safety system 100 through EMAC panel 112. Firefighters, for example, may be able to fill breathable air (e.g., breathable air 103, breathable air analogous to breathable air 103) into air bottles/cylinders (e.g., spare bottles, bottles requiring replenishment of breathable air) carried on mobile air unit 110 through safety system 100.

In FIG. 1, EMAC panel 112 is shown at two locations merely for the sake of illustrative convenience. In one or more embodiments, an air monitoring system 150 may be installed as part of safety system 100 to automatically track and monitor a parameter (e.g., pressure) and/or a quality (e.g., indicated by moisture levels, carbon monoxide levels) of breathable air 103 within safety system 100. FIG. 1 shows air monitoring system 150 as communicatively coupled to air storage system 106 and EMAC panel 112 merely for the sake of example. It should be noted that EMAC panel 112 may be at a remote location associated with (e.g., internal to, external to) structure 102. In one or more embodiments, for monitoring the parameters and/or the quality of breathable air within safety system 100, air monitoring system 150 include appropriate sensors and circuitries therein. For example, a pressure sensor (to be discussed) within air monitoring system 150 may automatically sense and record a pressure of breathable air 103 of safety system 100. Said pressure sensor may communicate with an alarm system that is triggered when the sensed pressure is outside a safety range. Also, in one or more embodiments, air monitoring system 150 may automatically trigger a shutdown of breathable air distribution through safety system 100 in case of impurity/contaminant (e.g., carbon monoxide) detection therethrough yielding levels above a safety/predetermined threshold.

In one or more embodiments, fixed piping system 104 may include pipes (c.g., constituted out of stainless steel tubing) that distribute breathable air 103 to a number of emergency air fill stations 120_{1-P} within structure 102. In one example implementation, each emergency air fill station 120_{1-P} may be located at a specific level of structure 102. If structure 102 is regarded as a vertical building structure, an emergency air fill station 120_{1-P} may be located at each of a basement level, a first floor level, a second floor level and so on. For example, emergency air fill station 120_{1-P} may be located at the end of the flight of stairs that emergency fighting personnel (e.g., firefighting personnel) need to climb to reach a specific floor level within the vertical building structure.

In one or more embodiments, an emergency air fill station 120_{1-P} may be a static location within a level of structure 102 that provides emergency personnel 122 (e.g., firefighters, emergency responders) with the ability to rapidly fill air bottles/cylinders (e.g., SCBA cylinders) with breathable air 103. In one or more embodiments, emergency air fill station 120_{1-P} may be an emergency air fill panel or a rupture containment air fill station. In one or more embodiments, proximate each emergency air fill station 120_{1-P}, safety system 100 may include an isolation valve 160_{1-P} to isolate a corresponding emergency air fill station 120_{1-P} from a rest of safety system 100. For example, said isolation may be achieved through the manual turning of isolation valve 160_{1-P} proximate the corresponding emergency air fill station 120_{1-P} or remotely (e.g., based on automatic turning) from air monitoring system 150. In one example implementation, air monitoring system 150 may maintain breathable air supply to a subset of emergency air fill stations 120_{1-P} via fixed piping system 104 through control of a corresponding subset of isolation valves 160_{1-P} and may isolate the other emergency air fill stations 120_{1-P} from the breathable air supply. It should be noted that configurations and components of safety system 100 may vary from the example safety system 100 of FIG. 1.

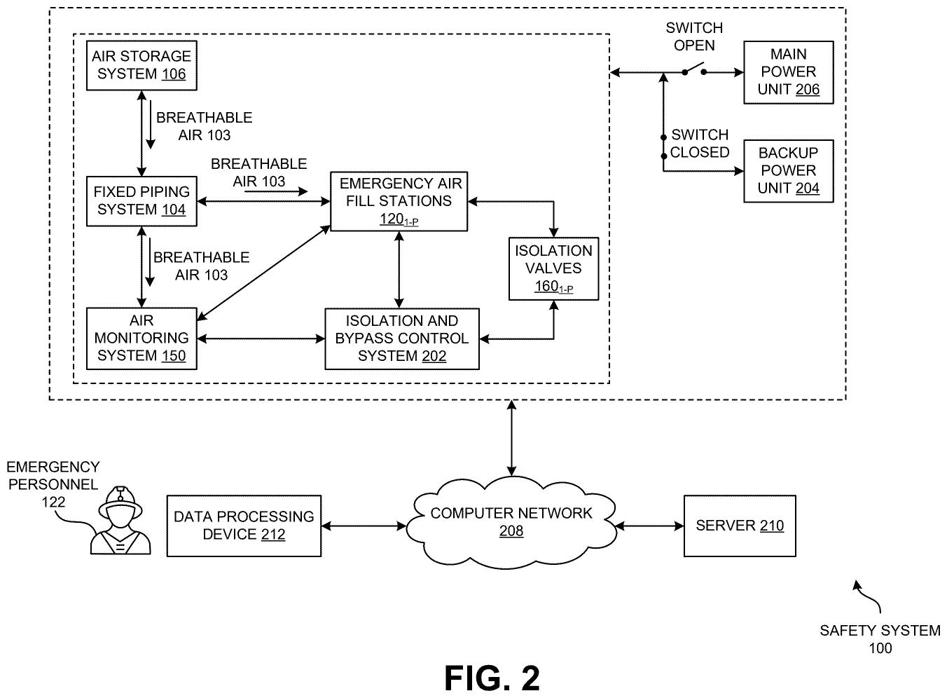

FIG. 2 shows safety system 100 with elements thereof integrated therewithin in detail, according to one or more embodiments. In one or more embodiments, safety system 100 may include air monitoring system 150 discussed above communicatively coupled to fixed piping system 104, to which emergency air fill stations 120_{1-P} are also coupled. In one or more embodiments, as seen above, the source of breathable air 103 may be air storage system 106. In one or more embodiments, safety system 100 may also include an isolation and bypass control system 202 that is constituted by a set of electrical, mechanical and/or electronic components working together to automatically include and/or bypass one or more emergency air fill station(s) 120_{1-P}. For the aforementioned purpose, in one or more embodiments, isolation valve(s) 160_{1-P} associated with the aforementioned emergency air fill stations 120_{1-P} may be controlled (e.g., by opening or closing one or more of said isolation valves 160_{1-P}) by isolation and bypass control system 202.

Further, in one or more embodiments, safety system 100 may include a backup power unit 204 (e.g., an electrical power system with electronic integration) to ensure uninterrupted power to components of safety system 100 during emergencies (e.g., a power cut, a mains power issue, a fire accident effected power issue). For the aforementioned purpose, in one or more embodiments, backup power unit 204 may be switched on in the case of a power related emergency with respect to a main power unit 206 (e.g., Alternating Current (AC) mains power, Direct Current (DC) power) associated with safety system 100.

In one or more embodiments, one or more or all of the abovementioned components of safety system 100 may be integrated with sensor(s) to detect environmental conditions thereof. In one or more embodiments, based on the detection of the environmental conditions thereof, camera devices (e.g., video and/or audio; to be discussed below) may be automatically turned on to capture visuals and/or audio data of environments associated with the one or more components of safety system 100. In one or more embodiments, the one or more components may be communicatively coupled through a computer network 208 (e.g., a Local Area Network (LAN), a Wide Area Network (WAN), a cloud computing network, a short-range communication network based on Bluetooth®, WiFi® and the like) to a remote server 210 (e.g., a network of servers, a single server, a distributed network of servers, a command room server associated with safety system 100 and so on). As will be discussed below, in one or more embodiments, server 210 may obtain data from the sensor(s), camera devices and other data from safety system 100, perform analyses (e.g., predictive, non-predictive) thereof and provide recommendations (e.g., situational awareness based) based on the analyses.

In addition, in one or more embodiments, safety system 100 may include a data processing device 212 (e.g., a mobile phone, a tablet, an iPad®, a laptop, a desktop) also communicatively coupled to one or more components or each component of safety system 100 and server 210 through computer network 208. Thus, in one or more embodiments, one or more components or each component of safety system 100 may have interfaces (not explicitly shown) for wireless communication through computer network 208. Also, as will be discussed below, in one or more embodiments, wherever possible, elements (e.g., handheld Thermal Imaging Cameras (TICs), portable TICs, acrial TICs, camera devices, audio devices, light devices, one or more or all sensors discussed herein) may be Internet of Things (IoT) devices capable of collecting and feeding data to server 210 through computer network 208. In one or more embodiments, IoT devices (or IoT enabled devices) may be devices and/or components with programmable hardware that can transmit data over computer networks (e.g., computer network 208 such as the Internet and/or other networks); said IoT devices may include or be associated with edge devices (not shown) to control data flow at the boundaries to computer network 208.

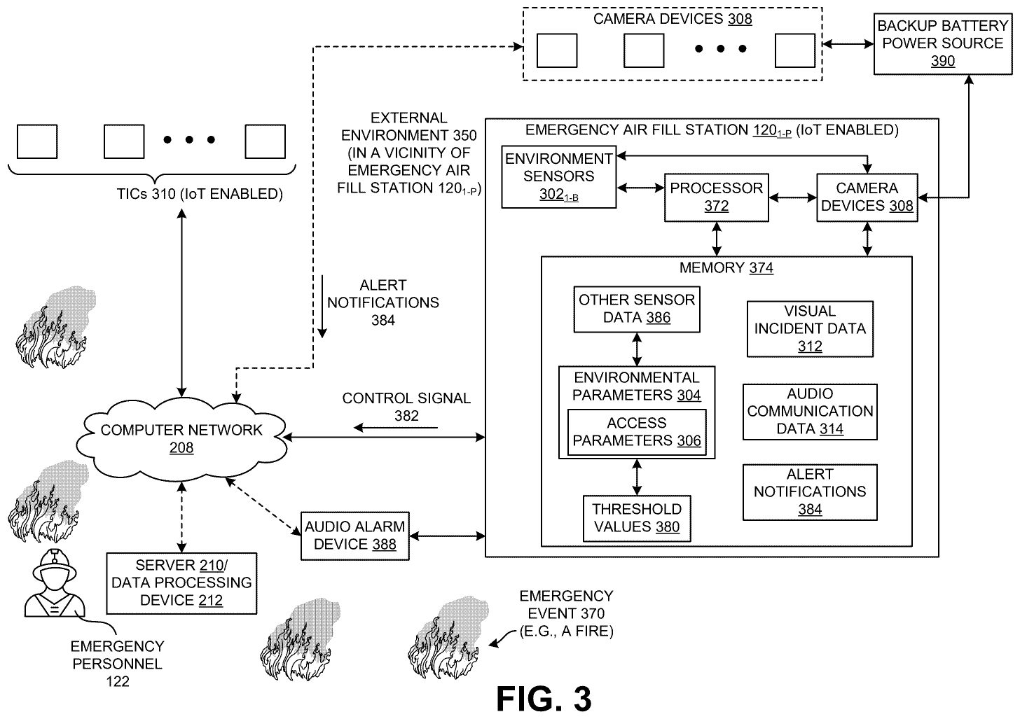

FIG. 3 shows an emergency air fill station 120_{1-P}, according to one or more embodiments. Again, in one or more embodiments, emergency air fill station 120_{1-P} may include one or more environment sensors 302_{1-B} integrated therewith configured to sense environmental parameters 304 (e.g., temperature, audio alarm detection (e.g., a person screaming “fire!”), pressure, smoke, motion, ambient light) associated with an environment (e.g., external environment 350) in an immediate vicinity of emergency air fill station 120_{1-P}. In one or more embodiments, environment sensors 302_{1-B} may also sense access (e.g., access parameters 306 that are part of environmental parameters 304 in FIG. 3) of and attempts to access emergency air fill station 120₁₋ by emergency personnel 122 (e.g., maintenance personnel, firefighters, emergency responders) and/or unauthorized personnel (e.g., example access by unauthorized personnel may involve tampering of one or more element(s) of emergency air fill station 120_{1-P}). In one or more embodiments, emergency air fill station 120_{1-P} may have one or more camera devices 308 integrated therewith or external (e.g., in external environment 350) thereto. In some embodiments, camera devices 308 may be considered as encompassing one or more environment sensors 302_{1-B} (e.g., motion detection sensors); FIG. 3 shows camera devices 308 as distinct from environment sensors 302_{1-B} merely for example purposes.

In one or more embodiments, emergency air fill station 120_{1-P} may include a processor 372 (e.g., a microcontroller, a processor core, a single processor) communicatively coupled to a memory 374 (e.g., a volatile and/or a non-volatile memory). In one or more embodiments, environment sensors 302_{1-B} may be interfaced with processor 372 and all of the abovementioned data/parameters (e.g., environmental parameters 304) may be stored in memory 374, as shown in FIG. 3. FIG. 3 also shows TICs 310 as part of safety system 100 and in external environment 350 of emergency air fill station 1201-p, according to one or more embodiments. In one or more embodiments, TICs 310 may be infrared cameras that sense infrared energy of objects to render images/video frames thereof corresponding to surface temperatures of said objects. In one or more embodiments, emergency personnel 122 may employ said TICs 310 to detect obstacles on the paths to/around emergency air fill stations 1201-p under low visibility; this may enable emergency personnel 122 perform rescue operations efficiently. As discussed and implied above, TICs 310 may be integrated with IoT capabilities to transmit data to server 210 through computer network 208. Said data may be part of access parameters 306 or separate data transmitted to server 210.

It should be noted that the sensing, detection and/or transmission of data to server 210 discussed above with regard to emergency air fill station 120_{1-P} may also be performed at a device external to emergency air fill station 120_{1-P}. In such implementations, the external device itself may obviously be a component of safety system 100 with IoT/wireless communication capabilities. While FIG. 3 has been discussed with regard to an emergency air fill station 120_{1-P}, concepts discussed herein may be applicable across other components of safety system 100 such as air monitoring system 150, air storage system 106, isolation and bypass control system 202 and even backup power unit 204.

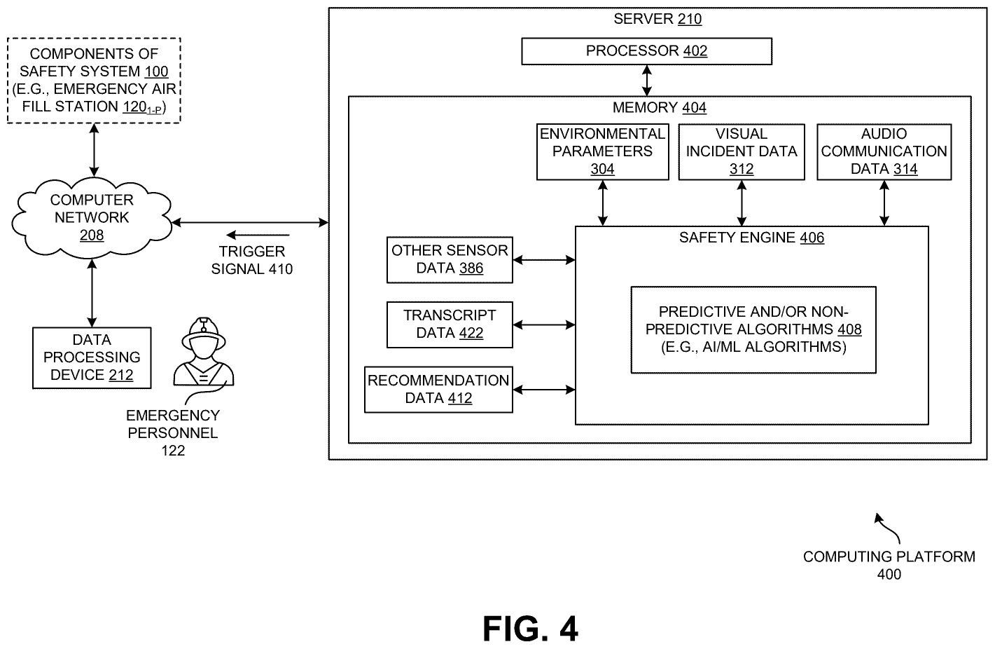

FIG. 4 shows a computing platform 400 relevant to the FARS of safety system 100 implemented through server 210, according to one or more embodiments. In one or more embodiments, server 210 may be a distributed (e.g., across a cloud) network of servers, a cluster of servers or a standalone server. As discussed above, in some embodiments, server 210 may be implemented as part of a fire command room within safety system 100; additionally or alternatively, server 210 may be implemented external to safety system 100. As shown in FIG. 4, server 210 may include a processor 402 (e.g., a processor core, a network of processors, a single processor), communicatively coupled to a memory 404 (e.g., a volatile and/or a non-volatile memory). In one or more embodiments, memory 404 may include a safety engine 406 associated with the FARS stored therein and executable through processor 402; safety engine 406 may integrate with environment sensors 302_{1-B} (and all other sensors within safety system 100) based on execution thereof through processor 402.

FIG. 4 shows memory 404 as including data (e.g., detected, sensed; environmental parameters 304) from one or more components of safety system 100; the limited amount of data shown must not be considered as limiting the scope of the exemplary embodiments discussed herein. In one or more embodiments, safety engine 406 may have one or more predictive and/or non-predictive algorithms (e.g., predictive and/or non-predictive algorithms 408) including Artificial Intelligence (AI)/Machine Learning (ML) based algorithms stored therein and executable through processor 402.

In one or more embodiments, execution of predictive and/or non-predictive algorithms 408 through processor 402 may involve taking the abovementioned data and providing analyses and/or recommendations, as discussed above. It should be noted that each of the aforementioned data (e.g., environmental parameters 304) may be real-time data from elements/components of safety system 100. In one or more embodiments, analyses of the data and recommendations may result in increased situational awareness during emergencies/maintenance situations and improved efficiency with regard to safety system 100 and safety/security thereof.

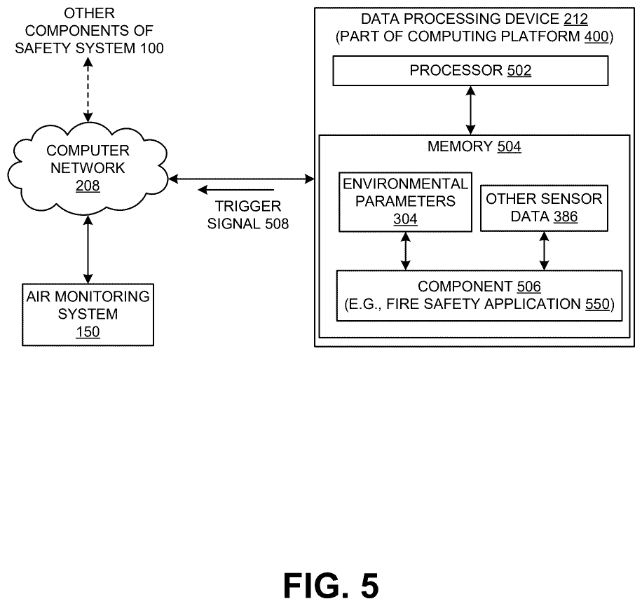

In one or more implementations, the components (e.g., emergency air fill station 120_{1-P}, air storage system 106, air monitoring system 150) of safety system 100 may automatically transmit data (e.g., environmental parameters 304) thereof to server 210; server 210 may transmit trigger signals (e.g., trigger signal 410) therefor. FIG. 5 shows data processing device 212 (e.g., a mobile phone, a tablet, a smart device, a laptop) in detail, according to one or more embodiments. In one or more embodiments, again, data processing device 212 may include a processor 502 (e.g., a single processor, a processor core) communicatively coupled to a memory 504 (e.g., a volatile and/or a non-volatile memory). In one or more embodiments, memory 504 may include a component 506 of safety engine 406 stored therein and enabled/provided through processor 402 of server 210. FIG. 5 shows component 506 as a fire safety application 550 merely for example purposes. Again, in one or more embodiments, access to the data of one or more components of safety system 100 may be available to data processing device 212 via component 506 (e.g., through computer network 208 via safety engine 406 of server 210). FIG. 5 also shows capabilities to control components of safety system 100 through data processing device 212 via trigger signals; FIG. 5 specifically shows a trigger signal 508 to initiate collection of data from air monitoring system 150 merely for example purposes. Again, in some implementations, data may be automatically communicated to data processing device 212 and in some others, data processing device 212 may trigger (e.g., through trigger signal 508) collection thereof.

Referring back to FIG. 3, each camera device 308 may be a programmable device to capture and record visual incidents and/or audio communications in external environment 350. In some implementations, camera devices 308 may be integrated with TICs 310; in some other implementations, camera devices 308 may be distinct from TICs 310; further, in some other implementations, camera devices 308 may be the same as TICs 310. In some embodiments, one or more camera devices 308 may include motion sensor(s) (e.g., example environment sensors 302_{1-B}) and/or facial recognition algorithms programmed therein to detect visual incidents such as tampering of emergency air fill station 120_{1-P} (and, analogously, other components of safety system 100).

FIG. 3 illustrates a fire as an example emergency event 370. In this context, a temperature of external environment 350 may exceed a threshold value thereof. The ambient temperature of external environment 350 may be detected by one or more environment sensors 302_{1-B}. As part of determining/detecting emergency event 370, processor 372 may determine that the temperature sensed through the one or more environment sensors 302_{1-B} exceeds the threshold value thereof to automatically activate one or more camera devices 308 to capture visual incidents and/or audio communication in external environment 350 associated with emergency event 370. FIG. 3 shows visual incident data 312 (e.g., images and/or video frames, a video sequence) and audio communication data 314 (e.g., audio accompanying visual incident data 312, separate audio data) being stored in memory 374 based on the capturing thereof through the one or more camera devices 308. It should be noted that memory 374 and/or processor 372 may even be part of the one or more camera devices 308.

In another scenario, environment sensors 302_{1-B} may include an audio level sensor to detect an ambient decibel level of audio/sound in external environment 350. Here, emergency event 370 may involve emergency personnel 122 or a potential victim screaming “Fire!” The aforementioned scream may cause a decibel level of the ambient sound to exceed a threshold value thereof; processor 372 may determine that the ambient decibel level is in excess of the threshold value thereof to automatically activate the one or more camera devices 308 (and/or TICs 310) discussed above to capture visual incident data 312 and audio communication data 314. In more sophisticated implementations, processor 372 may execute algorithms to glean emergency event 370 from an interpretation of audio communication data 314 in real-time; alternatively or additionally, audio communication data 314 and/or visual incident data 312 may be transmitted to server 210 and server 210 may glean emergency event 370 based on executing safety engine 406 to remotely activate the one or more camera devices 308 discussed above. It should be noted that the same remote operation may be performed through data processing device 212 based on executing component 506.

In one or more embodiments, emergency event 370 may include but is not limited to a fire hazard, an explosion, a smoke situation, a terrorist attack, tampering of one or more components of safety system 100, air pollution in external environment 350, increased hazardous components in breathable air 103, and reduced pressure of breathable air 103. In some implementations, emergency event 370 may even be a maintenance event or a simulated event (e.g., part of a demonstration of safety system 100 and/or one or more components thereof) based on triggering (e.g., through server 210, data processing device 212) environment sensors 302_{1-B} to detect anomalous environmental parameters 304 and/or processor 372 appropriately. Thus, environment sensors 302_{1-B} may also encompass internal pressure sensors configured to sense pressure of breathable air 103 and air component level sensors configured to sense levels of hazardous components of breathable air 103. FIG. 3 shows threshold values 380 used by processor 372 to determine emergency event 370 based on comparison of environmental parameters 304 with threshold values 380; based on the determination, processor 372 may automatically activate (e.g., based on transmitting a control signal 382 to the one or more camera devices 308) the one or more camera devices 308 discussed above.

In one or more embodiments, camera devices 308 (and TICs 310) may employ advanced night vision to capture visual incident data 312 during conditions of low visibility. In some implementations, one or more camera devices 308 may employ 360 degree pan-tilt-zoom (PTZ) features to enable emergency personnel 122 at server 210 and/or data processing device 212 to remotely control a movement and/or positioning (movement and/or positioning are merely two example camera device parameters) of the one or more camera devices 308 based on control signals therefor. Additionally, in one or more embodiments, the one or more camera devices 308 may transmit alert notifications (e.g., alert notifications 384 stored in memory 374) to server 210 and/or data processing device 212 related to alerting server 210 and/or data processing device 212 (e.g., through component 506) of emergency event 370.

Referring back to FIG. 4, server 210 may also store visual incident data 312 and audio communication data 314 in memory 404 for analyses thereof (to be discussed herein). For the aforementioned purpose, server 210 may also leverage cloud storage through computer network 208. In one or more implementations, environment sensors 302_{1-B} may be configured to detect environmental parameters 304 at all times and the one or more camera devices 308 discussed above may be activated solely during emergency event 370 to provide situational context to emergency personnel 122 at server 210 and/or data processing device 212 and/or personnel (e.g., authorized, unauthorized) within structure 100 in external environment 350. In one or more embodiments, predictive and/or non-predictive algorithms 408 executing as part of safety engine 406 on server 210 may even take visual incident data 312 and/or audio communication data 314 to generate a transcript (e.g., transcript data 422) thereof. Alternatively, transcript data 422 may be created based on leveraging cloud capabilities/services by server 210. In some implementations, processor 372 may itself generate transcript data 422.

As discussed above, in one or more embodiments, environmental parameters 304 may also be transmitted to server 210 and/or data processing device 212 for analysis thereat. In some implementations, predictive and/or non-predictive algorithms 408 executing on server 210 may analyze environmental parameters 304 and other sensor data 386 (in FIG. 3; e.g., data collected by environment sensors 302_{1-B}) to provide device renderable recommendations (e.g., device renderable recommendation data 412 shown stored in memory 404 of server 210). Recommendation data 412 may be associated with but may not be limited to preventive measures to control the fire discussed above as emergency event 370, optimizing resources, directing emergency personnel 122 via data processing device 212 (or one or more audio/video devices (e.g., a public speaker system) within safety system 100) across safety system 100 and generating an emergency map for effective evacuation of victims. Recommendation data 412 and/or transcript data 422, in some implementations, may be generated at data processing device 212 based on execution of component 506 thereon.

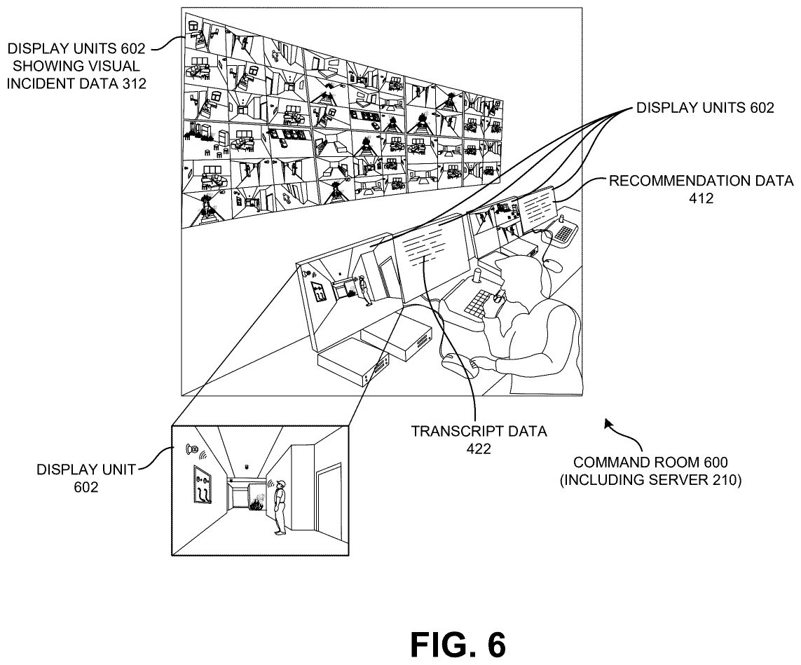

FIG. 6 shows an example command room 600 implementation of server 210. Here, server 210 may have a number of display units 602 associated therewith to view visual incident data 312 captured by the one or more camera devices 308 in real-time. In addition, one or more display units 602 may include audio rendering devices (not shown) thereon to render audio communication data 314 in real-time. Further, the one or more display units 602 may display transcript data 422 and/or recommendation data 412 discussed above. Referring back to FIG. 3, during emergency event 370, the one or more camera devices 308, in conjunction with processor 372 and/or remote communication from server 210/data processing device 212, may activate an audio alarm device 388 (e.g., rendering pre-recorded sound, rendering an audio message) to apprise emergency personnel 122/other personnel within structure 102, at server 210, at data processing device 212 and/or within command room 600 of emergency event 370. In one or more embodiments, the one or more camera devices 308 discussed above may have a backup battery power source 390 associated therewith to supply interrupted power thereto during emergency event 370 (e.g., associated with power interruption).

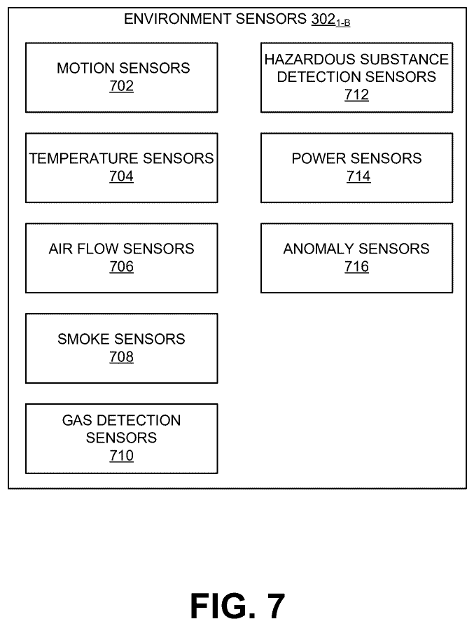

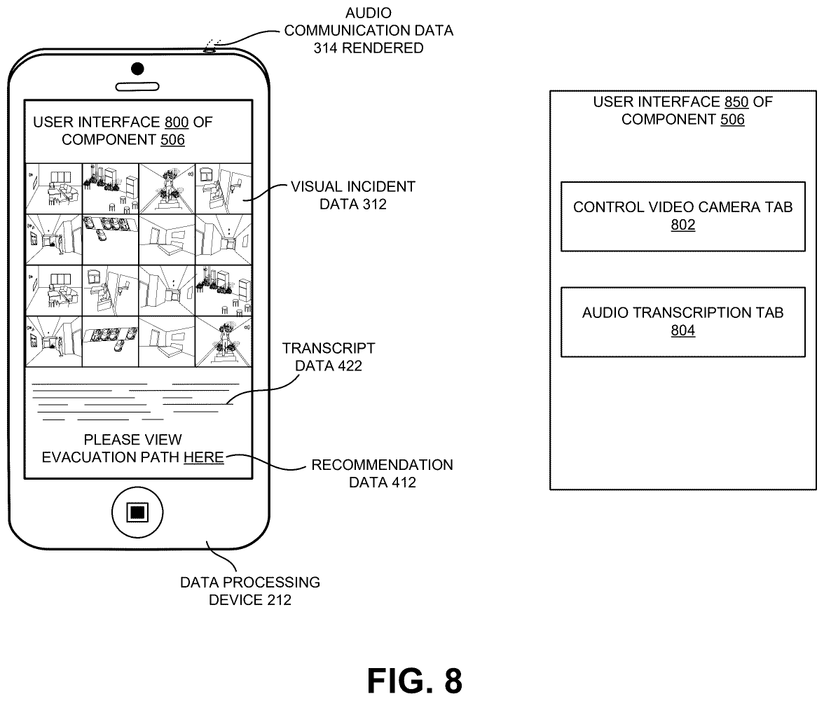

FIG. 7 shows examples of environment sensors 302_{1-B}. As seen in FIG. 7, environment sensors 302_{1-B} may include but are not limited to motion sensors 702, a temperature sensor 704, air flow sensors 706, smoke sensors 708, gas detection sensors 710, hazardous substance detection sensors 712, power sensors 714 and anomaly sensors 716 (e.g., sensing malfunctioning of equipment). FIG. 8 shows visual incident data 312 and audio communication data 314 being rendered via component 506 (e.g., fire safety application 550) executing on data processing device 212. Again, transcript data 422 and/or recommendation data 412 may be rendered via a user interface 800 of component 506. Emergency personnel 122 may control (e.g., through control video camera tab 802) the one or more camera devices 308 discussed above and transcribe (e.g., using audio transcription tab 804) audio communication data 314 via another user interface 850 of component 506.

Thus, exemplary embodiments discussed herein may serve as an advance surveillance system implemented as part of safety system 100. The capabilities discussed herein may enable safety system 100 to provide better situational awareness to emergency personnel 122 at server 210, control room 600, data processing device 122 and/or other personnel within structure 102. Further, in one or more embodiments, safety system 100 discussed herein may provide for efficient contextual monitoring of safety system 100 and transmitting actionable recommendations viewable, hearable and/or readable by emergency personnel 122/other personnel within structure 102. It should be noted that all operations and/or functionalities discussed herein may be performed through one or processors (e.g., processor 372, processor 402, processor 502) of one or more data processing devices (e.g., emergency air fill station 120_{1-P}, server 210, data processing device 212) of safety system 100 discussed above in conjunction with one or more other elements (e.g., environment sensors 302_{1-B}).

Also, it should be noted that both component 506 and safety engine 406 may be regarded as a computing platform analogous to computing platform 400 based on capabilities (e.g., including integration capabilities) provided thereto. Further, it should be noted that environment sensors 302_{1-B} may not only sense parameters relevant to external environment 350 but also sense internal parameters relevant to emergency air fill station 120_{1-P}. The same discussion may analogously be applicable to other components of safety system 100 (e.g., air monitoring system 150, air storage system 106, isolation and bypass control system 202, backup power unit 204). Last but not the least, emergency event 370 discussed above may be generalized to detection of any incident (e.g., a real-time incident determined based on environmental parameters 304). All reasonable variations are within the scope of the exemplary embodiments discussed herein.

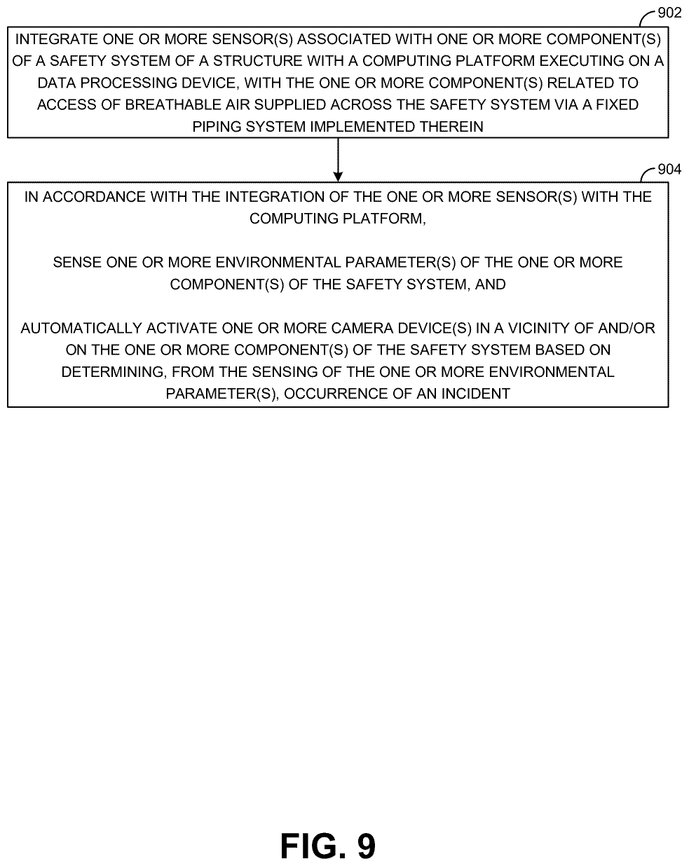

FIG. 9 shows a process flow diagram detailing the operations involved in incident based camera device activation in a safety system (e.g., safety system 100) of a structure (e.g., structure 102) having breathable air (e.g., breathable air 103) supplied therein via a fixed piping system (e.g., fixed piping system 104), according to one or more embodiments. In one or more embodiments, operation 902 may involve integrating one or more sensor(s) (e.g., environment sensors 302_{1-B}) associated with one or more component(s) (e.g., emergency air fill station 120₁₋ₚ, air monitoring system 150, air storage system 106, isolation and bypass control system 202) of the safety system with a computing platform (e.g., safety engine 406, component 506) executing on a data processing device (e.g., server 210, data processing device 212). In one or more embodiments, the one or more component(s) may relate to access of the breathable air within the safety system.

In one or more embodiments, operation 904 may then involve, in accordance with the integration of the one or more sensor(s) with the computing platform, sensing one or more environmental parameter(s) (e.g., environmental parameters 304) of the one or more component(s) of the safety system, and automatically activating one or more camera device(s) (e.g., camera devices 308) in a vicinity (e.g., in external environment 350) of and/or on the one or more component(s) of the safety system based on determining, from the sensing of the one or more environmental parameter(s), occurrence of an incident (e.g., emergency event 370).

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1.-20. (canceled)

21. A safety system of a structure, comprising:
at least one component configured to supply breathable air within the safety system;
at least one sensor associated with the at least one component; and
a fire detection system in communication within the at least one sensor and configured to execute on at least one data processing device, the fire detection system comprising one or more processors to:
detect, using the at least one sensor, that an environmental parameter within the safety system of the structure exceeds a threshold, the environmental parameter includes one or more of pressure, smoke, motion, audio detection, temperature, or ambient light;
identify an occurrence of an event corresponding to the environmental parameter, in response to the detection of the environmental parameter exceeding the threshold;
determine, using a location associated with the at least one sensor detecting the environmental parameter, a vicinity of the event, in response to the occurrence of the event; and
activate, within the vicinity of the event, at least one data processing device to receive incident data associated with the event and the at least one component of the safety system to perform an action based on the incident data.

22. The safety system of claim 21, wherein the event includes one or more of a fire hazard, an explosion, smoke hazard, tampering of the at least one component of the safety system, air pollution, or reduced pressure.

23. The safety system of claim 21, comprising the one or more processors to:
receive, from the at least one sensor, an alert notification corresponding to the occurrence of the event, the alert notification including the incident data associated with the event; and
transmit, to the at least one data processing device, the alert notification.

24. The safety system of claim 21, comprising the one or more processors to:
trigger the at least one data processing device to transmit, to the at least one sensor, a signal to collect data associated with the environmental parameter, responsive to an absence of the event.

25. The safety system of claim 22, comprising the one or more processors to:
identify the location of the at least one sensor based on the data associated with the environmental parameter.

26. The safety system of claim 21, wherein the at least one sensor is a camera device integrated within the at least one component and configured to obtain the incident data.

27. The safety system of claim 21, wherein the incident data includes visual data and audio data of the event.

28. The safety system of claim 27, comprising the one or more processors to:
provide, to a server for display on one or more display units, a transcript of the visual data and the audio data of the event.

29. The safety system of claim 27, comprising the one or more processors to:
provide, to a server for display on one or more display units, a recommendation for the event based on an analysis of the visual data, the audio data and the detected at least one environmental parameter.

30. The safety system of claim 21, wherein the at least one component is IoT enabled.

31. A method, comprising:
integrating at least one sensor associated with at least one component of a safety system with a fire detection system executing one at least one data processing device, the at least one component to supply breathable air within the safety system;
detecting, by the fire detection system using the at least one sensor, that an environmental parameter within the safety system of a structure exceeds a threshold, the environmental parameter includes one or more of pressure, smoke, motion, audio detection, temperature, or ambient light;
identifying, by the fire detection system, an occurrence of an event corresponding to the environmental parameter, in response to the detection of the environmental parameter exceeding the threshold;
determining, by the fire detection system using a location associated with the at least one sensor detecting the environmental parameter, a vicinity of the event, in response to the occurrence of the event; and
activating, by the fire detection system, within the vicinity of the event, at least one data processing device to receive incident data associated with the event and the at least one component of the method to perform an action based on the incident data.

32. The method of claim 31, wherein the event includes one or more of a fire hazard, an explosion, smoke hazard, tampering of the at least one component of the method, air pollution, or reduced pressure.

33. The method of claim 31, further comprising:
receiving, by the fire detection system from the at least one sensor, an alert notification corresponding to the occurrence of the event, the alert notification including the incident data associated with the event; and
transmitting, by the fire detection system to the at least one data processing device, the alert notification.

34. The method of claim 31, further comprises trigger the at least one data processing device to transmitting, by the fire detection system to the at least one sensor, a signal to collect data associated with the environmental parameter, responsive to an absence of the event.

35. The method of claim 32, further comprises identifying, by the fire detection system, the location of the at least one sensor based on the data associated with the environmental parameter.

36. The method of claim 31, wherein the at least one sensor is a camera device integrated within the at least one component and obtains the incident data.

37. The method of claim 31, wherein the incident data includes visual data and audio data of the event.

38. The method of claim 37, further comprises providing, by the fire detection system to a server for display on one or more display units, a transcript of the visual data and the audio data of the event.

39. The method of claim 37, further comprises providing, by the fire detection system to a server for display on one or more display units, a recommendation for the event based on an analysis of the visual data, the audio data and the detected at least one environmental parameter.

40. The method of claim 31. wherein the at least one component is IoT enabled.
